(19) United States
(12) Patent Application Publication
(10) Pub. No.: US 2003/0046225 A1
(43) Pub. Date: Mar. 6, 2003

(54) Fund transfer system and processing method of instruction data for fund transfer in the system

(75) Inventors: Yoshihiro Yamaguchi, Kawasaki (JP); Soichiro Uchida, Tokyo (JP); Shinichiro Inoue, Kawasaki (JP); Tomohide Koyama, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/062,628

(22) Filed: Jan. 30, 2002

(30) Foreign Application Priority Data
Aug. 31, 2001 (JP) 2001-262603

(51) Int. Cl. G06F 17/60

(52) U.S. Cl. 705/39

(57) ABSTRACT

An Internet banking center (center) is established which mediates between fund transfer utilizing business enterprises and a fund transfer dealing financial institution system, and fund transfer fee databases of customers and a beneficiary's account database in which a beneficiary's account fee for each of customers is stored are held in the Internet banking system. The remote maintenance of the fund transfer fee databases is carried out from the financial institution side, while with respect to the beneficiary's account database, each of customers maintains a part thereof associated with himself/herself.

### BACKGROUND OF THE INVENTION

1. Field of the Invention

The present invention relates to a fund transfer system for supporting a fund transfer processing and a processing method of instruction data for fund transfer in the system.

2. Description of the Related Art

In general, business enterprises, as a method of settling the cash debts generated by dealings or the like, utilize a method of transferring the funds possessed in their own accounts in financial institutions such as banks to the accounts of beneficiaries by the fund transfer. Financial institutions impose the transfer fees from applicants to transfer the funds between accounts. Financial institutions may, as the business strategy, set the standard fee, and the reduction and exemption fee lower than the standard fee in the transfer fee and may apply the reduction and exemption fee to customers to give favorable treatment to them in some cases. On the other hand, each of business enterprises may settle a sum of money of a fee for the fund transfer and a person on who the burden for a fee is imposed between the persons concerned in some cases. For this reason, with respect to a fee for the fund transfer, there are present (1) the distinction between the standard fee and the reduction and exemption fee concerned in a sum of money of a fee which the associated business enterprise imposes, (2) the distinction between the applicant's account and the beneficiary's account concerned in a person who must bear a fee, (3) the distinction between the payment specification in arrear and the payment specification on transfer (by the payment specification on transfer is meant the specification in which a fee is paid whenever the fund transfer is carried out, and by the payment specification in arrear is meant the specification in which a fee is paid on the basis of the payment in arrear) concerned in the time when a fee for the fund transfer must be paid, and so forth.

Heretofore, as the plan, on the side of the business enterprises utilizing the fund transfer, for carrying out smoothly the fund transfer processing, there is known the firm banking. FIG. 15 is a view useful in explaining a conventional fund transfer system when the firm banking is utilized. The firm banking is realized by a personal computer 1502 and the like connected to a basic system 1501 of a financial institution, and has in its inside a fee database 1503. The maintenance such as the management, and the update of this fee database 1503 is carried out by the associated one of customers 1510 of the firm banking. For the fund transfer employing the firm banking system, there are the file transmission processing of transmitting fund transfer data in the form of a telegraphic message to a financial institution to subject collectively the telegraphic messages received on the side of the financial institution to the batch processing, and the online processing of subjecting the fund transfer to the online processing every matter. The online processing is executed via an online processing relay center (not shown) lay between the firm banking and the financial institution basic system.

In the case of the file transmission processing, the associated one of customers 1510 activates a firm banking program 1504 of the personal computer 1502 to input a sum of money of the fund transfer to calculates a fee using the data stored in the fee database 1503. Thereafter, the data is transmitted to the basic system 1501 of the financial institution to make an instruction of transferring the funds. The financial institution carries out the transfer of the funds for which it has received the instruction, thereby informing a business enterprise which has made an instruction of the result by a method 1505 such as the mail service. On the other hand, in the case of the online processing, the customer 1510 activates a firm banking program 1506 of the personal computer 1502 to calculate a fee to input the data of a sum of money for the fund transfer and then transmits the data to the basic system 1501 of the financial institution to make an instruction for the transfer of the funds. Then, in the financial institution, the transfer of the funds corresponding to the instructed contents is carried out to return the result back thereto. The result is displayed on the screen of the personal computer 1502.

FIG. 16 is a flow chart useful in explaining an example of the processing procedure in the case of the file transmission processing in the firm banking system. In this case, the description will hereinbelow be given by giving as an example the case where a sum of money 10,000 yen is transferred from a applicant α to a remittee β on the basis of the beneficiary's account for the fee (the settled free between the applicant α and the remittee β is 500 yen. By the way, it is assumed that the fund transfer fee which a financial institution imposes from the applicant α is 200 yen.

First of all, the applicant α logs in the firm banking system through a terminal which is installed every customer of the firm banking system (Step 1601). Then, the firm banking system executes the reception processing to display the input data on the screen of the terminal (Step 1611). Next, the applicant α inputs the data relating to the business, a fund transfer data, a sum of money of the fund transfer, a paying-in account, a paying-out account and the distinction between the applicant's account and the beneficiary's account (Step 1602). In response to that input, the firm banking system calculates a fee. With respect to the calculation for a fee, to put it concretely, it is judged whether a person on who a burden for a fee is imposed is an applicant or a remittee (Step 1612) to retrieve the beneficiary's account database in the firm banking with the remittee β as a key to obtain a fee of 500 yen for which a burden is imposed on the remittee β since this case corresponds to the beneficiary's account)(Step 1613).

Next, the firm banking system calculates a sum of money which is to be remitted to the remittee β on the basis of a sum of money of the fund transfer and the fee to execute the confirmation processing. In this example, since a sum of money of the fund transfer is 10,000 yen and the fee of the beneficiary's account is 500 yen, the information that a sum of money for remittance to the remittee's account is 9,500 yen (=10,000 yen−500 yen) is displayed on the screen to obtain the confirmation thereof (Step 1614). Then, the applicant α confirms this information at the terminal to instruct the firm banking system to continue the processing (Step 1603). In addition, a sum of money remitted to a B bank account of the remittee β of 9,500 yen and the fee therefor of 500 yen are entered in a book.

On the other hand, in response to the instruction to continue the processing, the firm banking system transmits the instruction to move the funds of 9,500 yen from the applicant's account of an A bank to a the remittee's account of a B bank to the basic system of the associated one of the financial institutions (Step 1615). In response to the instruction to move the funds from the firm banking system of the applicant α, the basic system of the financial institution carried out the transfer of the funds in accordance with the instruction. To put is concretely, a sum of money of 9,700 yen which is obtained by adding the fee of 200 yen to a sum of money for remittance of 9,500 yen is curtailed from a deposit in the applicant's account and 200 yen of it is imposed as the fee and remaining 9,500 yen is remitted to the remittee's account (Step 1631). Therefore, the financial institution informs the applicant α of the result in the form of the mail service. The applicant α who has been informed of the result corrects the fee of 500 yen which is previously entered into the book into 200 yen.

While the firm banking system holds the data of the standard fee and the reduction and exemption fee which the financial institution lays on the applicant α in its recording unit, since the firm banking system itself is under the management made by customers, the value held therein is the reference value to the utmost and hence is not necessarily accurate. For this reason, in the case of the fund transfer by the firm banking, the fee which is recognized by an applicant when carrying out the fund transfer may be inaccurate in some cases, and at the stage when having notice from the financial institution later, it is necessary to confirm a sum of money for a fee in the book or to correct the same as the case may be. As a result, there arises the problem that the processing relating to a fee for the fund transfer becomes complicated. In addition, in the case where a fee for the fund transfer is changed, an applicant as a customer or the person in charge of the business in the financial institution needs to correct the data, which is held by the fee database in the firm banking system, by the hand work. Furthermore, there arises the problem that a customer side can not use the payment specification in arrear and the payment specification on transfer appropriately, a customer can not retrieve simply a fee for each of the fund transfer cases, or so forth.

In addition, there arises the problem that even in the online processing in the firm banking, the dealings of the reduction and exemption fee can not be carried out, the dealings of the beneficiary's account can not be carried out, even the standard fee can not be dealt with during the unconnection of the basic system in the financial institution, or so forth.

### SUMMARY OF THE INVENTION

In the light of the foregoing, the present invention has been made in order to solve the above-mentioned problems associated with the current fund transfer system employing the firm banking, and it is therefore an object of the present invention to simplify the management for a fee for the fund transfer in business enterprises.

In order to attain the above-mentioned objects, in the present invention, a corporation Internet banking (fund transfer center) is provided which mediates between business enterprises each utilizing the fund transfer and a financial institution system dealing with the fund transfer, and a fund transfer fee database for a corporation (business enterprise) and the beneficiary's account database in which the beneficiary's account fee for each of business enterprises is stored are held in the Internet banking. In addition, the remote maintenance of the fund transfer fee database can be carried out from the financial institution side. Or, the contents of the fund transfer fee database can be updated on the basis of the on-demand for the basic system of the financial institution. For the beneficiary's account database, the parts thereof in which the business enterprises themselves are concerned can be maintained by the business enterprises, respectively.

That is, a fund transfer center system according to the present invention includes: a database in which standard fee data for fund transfer, reduction and exemption fee data, and data in which whether the fund transfer fee to be applied to each of fund transfer instruction sources is the standard fee or the reduction and exemption fee is described are stored separately for financial institutions; and a database in which the beneficiary's account fee data for fund transfer is stored separately for fund transfer instructions. In addition, the fund transfer center system includes a fund transfer processing unit for retrieving both of the above-mentioned databases on the basis of the information which is contained in fund transfer instruction information received from a customer terminal of an applicant and which exhibits a dealing financial institution, a fund transfer instruction source, a sum of money of fund transfer, a destination for fund transfer, a burden source for fund transfer fee, and the like, for calculating a fund transfer fee which a fund transfer instruction source is to pay to a dealing financial institution and a sum of money of fund transfer to the specified paying-in account, for transmitting the information of the fund transfer fee and a sum of money of fund transfer which have been calculated to a customer terminal of the applicant, and for instructing a system of the dealing financial institution to transfer the funds.

In addition, the fund transfer processing unit, when the fund transfer fee corresponds to the beneficiary's account, retrieves the database on the basis of the information of an applicant and a remittee to obtain a fee which is charged to the destination of the fund transfer and to deduct the fee of interest from a sum of money of the fund transfer, thereby calculating a sum of money which is to be transferred to the specified paying-in account.

The fund transfer center system manages the update access authority to the database every area, and permits a predetermined financial institution and an applicant to access a predetermined area.

According to the present invention, there is provided a fund transfer instruction information processing method of when receiving a fund transfer instruction, calculating a fee required for the fund transfer institution in a center apparatus connected to customer terminals and having a database, wherein there are successively executed the steps of: receiving fund transfer instruction information as information, on the basis of which the fund transfer from a predetermined paying-out account to a predetermined paying-in account is instructed, from the associated one of the customer terminals; retrieving a fund transfer fee which has been set in a customer who transmitted fund transfer instruction information, and a beneficiary's account fee which when carrying out the fund transfer to the predetermined paying-in account, the customer receives from a remittee for the fund transfer from the database on the basis of customer identification information contained in the fund transfer instruction information; calculating a sum of money which is to be curtailed from the predetermined paying-out account on the basis of the fund transfer instruction information, the above-mentioned fund transfer fee thus set and the beneficiary's account fee; and transmitting the sum of money thus calculated and the fund transfer fee to the associated one of the customer terminals. Also, the beneficiary's account fee may be zero in some cases.

In addition, according to the present invention, there is provided a fee calculating method of when receiving an instruction to process fund transfer, calculating a fee required for the fund transfer processing in a center apparatus connected to customer terminals, wherein there are successively executed the steps of: receiving fund transfer instruction information from the associated one of the customer terminals; referring to a customer information recording unit in which the information of customers is stored on the basis of customer identification information contained in the fund transfer instruction information to judge whether or not a reduction and exemption fee is set in the customer who has transmitted the fund transfer instruction information; when the reduction and exemption fee is set in the customer who has transmitted the fund transfer instruction information, referring to a reduction and exemption information recording unit to calculate, on the basis of paying-out account information and paying-in account information contained in the fund transfer instruction information, a fee when the customer who has transmitted the fund transfer instruction transfers the funds from an account exhibited in the paying-out account information to an account exhibited in the paying-in account information; judging on the basis the fund transfer instruction information whether or not the fee required for the fund transfer processing exhibited in the fund transfer instruction information is charged to the customer who has transmitted the fund transfer instruction information of interest; when such a fee required for the fund transfer processing exhibited in the fund transfer instruction information is not charged to the customer who has transmitted the fund transfer instruction information of interest, retrieving a beneficiary's account fee which is set by the customer who has transmitted the fund transfer instruction information from a beneficiary's account information recording unit; calculating a sum of money which is curtailed along with the fund transfer based on the fund transfer instruction information from the paying-out account on the basis of the beneficiary's account fee thus retrieved, the fee required when carrying out the above-mentioned fund transfer, and a sum of money for the fund transfer exhibited in the fund transfer instruction information; and transmitting the sum of money thus calculated and the fee when carrying out the above-mentioned fund transfer to the associated one of the customer terminals.

### BRIEF DESCRIPTION OF THE DRAWINGS

The above and other objects as well as advantages of the present invention will become clear by the following description of the embodiments of the present invention with reference to the accompanying drawings, wherein:

FIG. 1 is a block diagram useful in explaining schematically a fund transfer system according to the present invention;

FIG. 2 is a view showing an example of the contents of a customer database which is held by an IB center;

FIG. 3 is a view showing an example of the contents of a standard fee database which is held by the IB center;

FIG. 4 is a view showing an example of the contents of a reduction and exemption fee database which is held by the IB center;

FIG. 5 is a view showing an example of the contents of a beneficiary's account database which is held by the IB center;

FIG. 6 is a view showing an example of the contents of a customer database which a bank holds in its basic system;

FIG. 7 is a view showing an example of the contents of a standard fee database which a bank holds in its basic system;

FIG. 8 is a view showing an example of the contents of a reduction and exemption fee database which a bank holds in its basic system;

FIG. 9A and FIG. 9B are respectively views each showing an example of data which is inputted through a browser on a business enterprise terminal when carrying out the fund transfer;

FIG. 10 is a flow chart useful in explaining an example of a fund transfer processing in the case of a file transmission processing, the payment specification on transfer and an applicant's account;

FIG. 11 is a flow chart useful in explaining an example of a fund transfer processing in the case of a file transmission processing, the specification on demand and a beneficiary's account;

FIG. 12 is a flow chart useful in explaining a processing in the case of the payment specification in arrear;

FIG. 13 is a flow chart useful in explaining an on-demand data updating processing in a database;

FIG. 14 is a flow chart useful in explaining remote maintenance for databases;

FIG. 15 is a diagram useful in explaining a conventional fund transfer system utilizing firm banking; and

FIG. 16 is a flow chart useful in explaining an example of a processing procedure in the case of a file transmission processing in the firm banking.

### DESCRIPTION OF THE EMBODIMENTS

The embodiments of the present invention will hereinafter be described in detail with reference to the accompanying drawings. While the description will hereinafter be given with respect to the case where financial institutions are banks, the implementation of the present invention is not intended to be limited to banks.

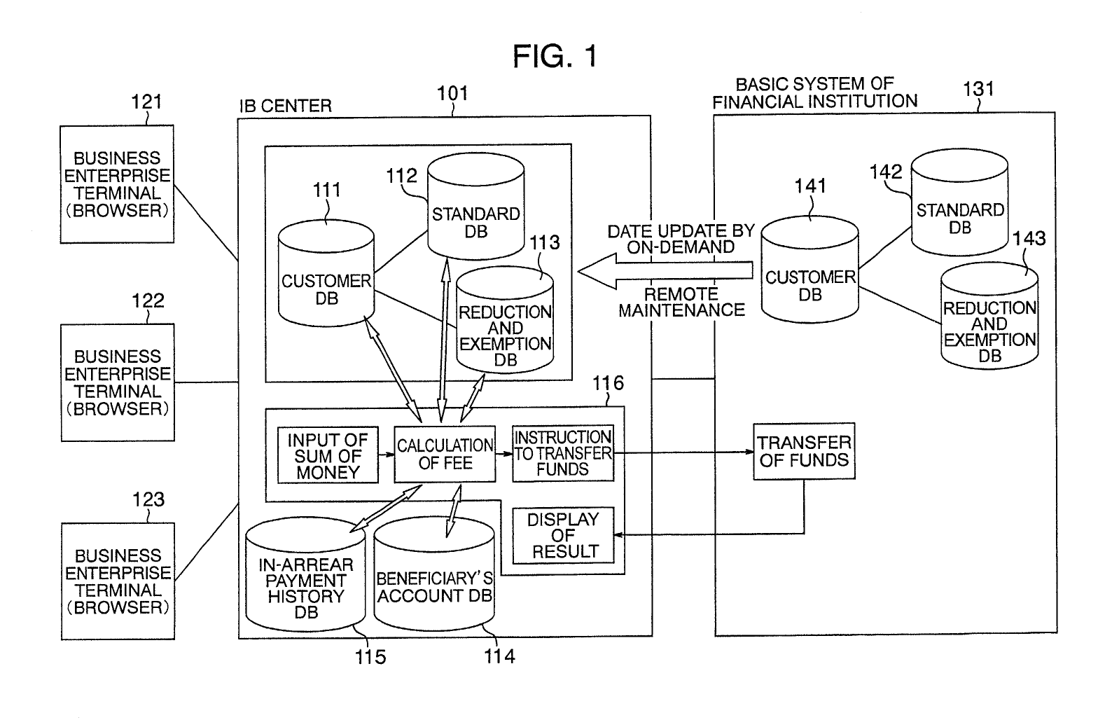

FIG. 1 is a block diagram useful in explaining schematically a fund transfer system according to the present invention. This fund transfer system includes an Internet banking center(IB center: hereinafter referred to as “a center” for short, when applicable) 101. The center 101 includes a customer database 111, a standard fee database 112, a reduction and exemption fee database 113, a beneficiary's account database 114, an in-arrear payment history database 115, and a fund transfer processing program 116, and is connected to a basic system 131 of each of banks, and also is connected to terminals 121, 122, 123, . . . on the customer side through a communication network such as the Internet.

A customer accesses the center 101 through the associated one of the terminals 121, 122, 123, . . . which are installed every customer to carry out the fund transfer processing. The fund transfer processing program 116, at the time when the data, required for the fund transfer, such as a fund transfer date, a sum of money of the fund transfer, a paying-in bank account and a paying-out bank account has been inputted through the associated one of the terminals 121, 122, 123, . . . , calculates a fee for the fund transfer using the databases 111 to 114 to transmit the fund transfer instruction to the basic system 131 of the specified bank. The bank basic system 131 which has received the fund transfer instruction from the center 101 carries out the instructed fund transfer to return the result back to the center 101. This result is displayed on the associated one of the terminals 121, 122, 123, . . . of customers so that a customer can confirm the result of the fund transfer.

Each of banks includes a customer database 141, a standard fee database 142, and a reduction and exemption fee database 143 and is adapted to subject each of the customer database 111, the standard fee database 112 and the reduction and exemption fee database 113 which are held by the center 101 to the date update or the remote maintenance in the on-demand manner. On the other hand, the maintenance of the data in the beneficiary's account database 114 which is held by the center 101 is carried out by each of customers.

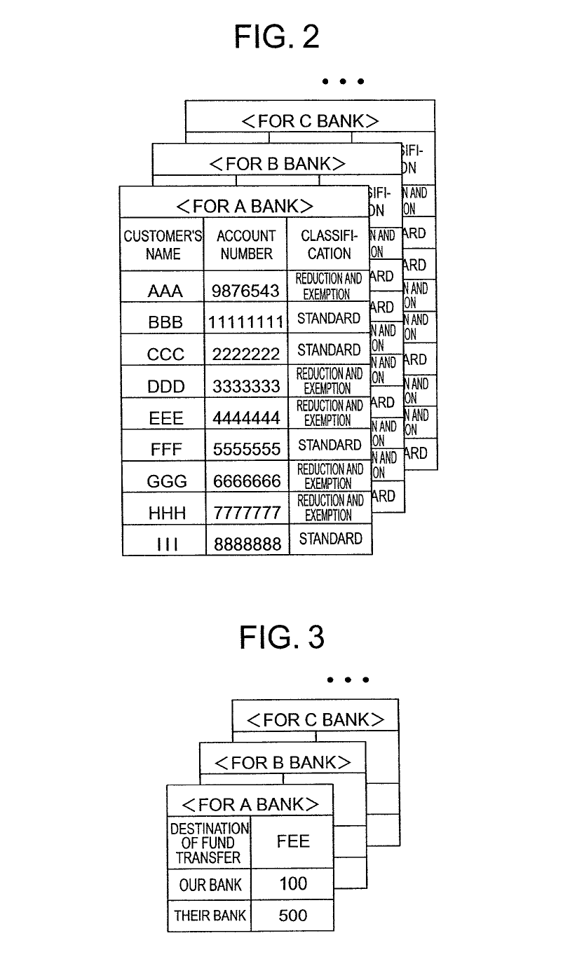

FIG. 2 is a view showing an example of the contents of the customer database 111 which is held by the center 101. The customer database 111 has a table for each of bank, and a customer's name, an account number and the data exhibiting whether the standard fee or the reduction and exemption fee is applied to the associated one of customers are respectively stored in the table. For example, in FIG. 2, an A bank applies the reduction and exemption fee to the fund transfer by a customer AAA, while applies the standard fee to the fund transfer by a customer BBB.

FIG. 3 is a view showing an example of the contents of the standard fee database 112 which is held by the center. The standard fee database 112 includes a table for each of bank in which a sum of money of the standard fund transfer fee order for our bank itself and a sum of money of the standard fund transfer fee order for their bank are respectively stored every bank. For example, in FIG. 3, the A bank sets the fund transfer fee order for the A bank itself to 100 yen, while sets the fund transfer fee order for their bank to 500 yen.

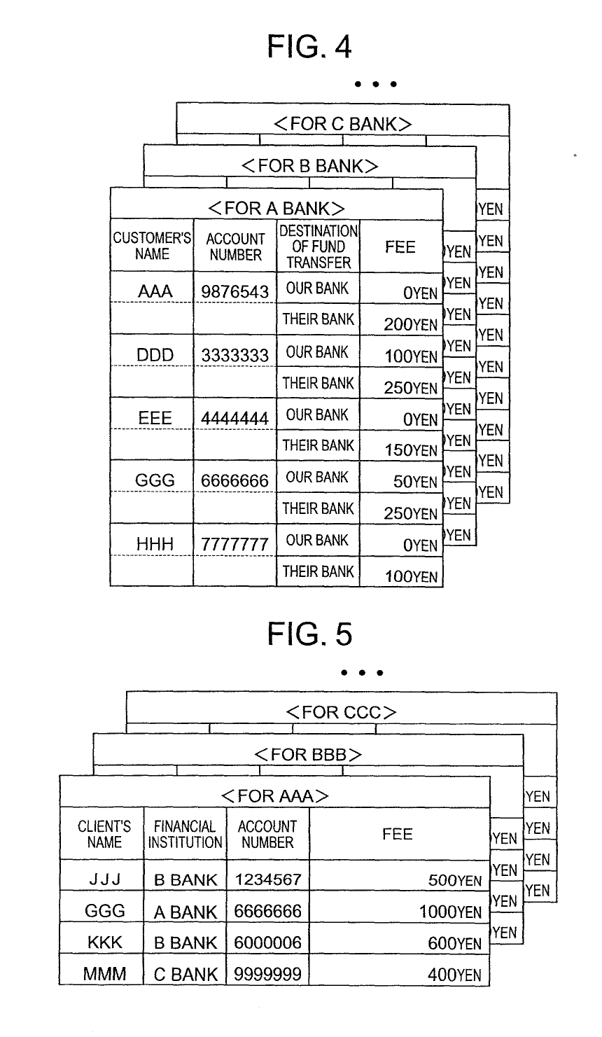

FIG. 4 is a view showing an example of the contents of the reduction and exemption fee database 113 which is held by the center. The reduction and exemption fee database 113 includes a table for each of bank in which a sum of money of the reduction and exemption fund transfer fee order for our bank and a sum of money of the reduction and exemption fund transfer fee order for their bank are respectively stored every customer. For example, in FIG. 4, the A bank makes the fund transfer fee of the customer AAA order for the B bank free of charge (the standard fee, as shown in FIG. 3, is 100 yen), while sets the fund transfer fee of the customer AAA order for their bank to 200 yen (the standard fee, as shown in FIG. 3, is 500 yen).

FIG. 5 is a view showing an example of the contents of the beneficiary's account database 114 which is held by the center. The beneficiary's account database 114 includes a table for each of customers in which the holder's name of a paying-in account, a bunk as the destination of the fund transfer, an account number of the destination of the fund transfer and the beneficiary's account fee are respectively stored. For example, it is understood from FIG. 5 that with respect to the fund transfer from the customer AAA to a client JJJ, the settlement is decided in such a way that JJJ shoulder 500 yen as the fund transfers fee.

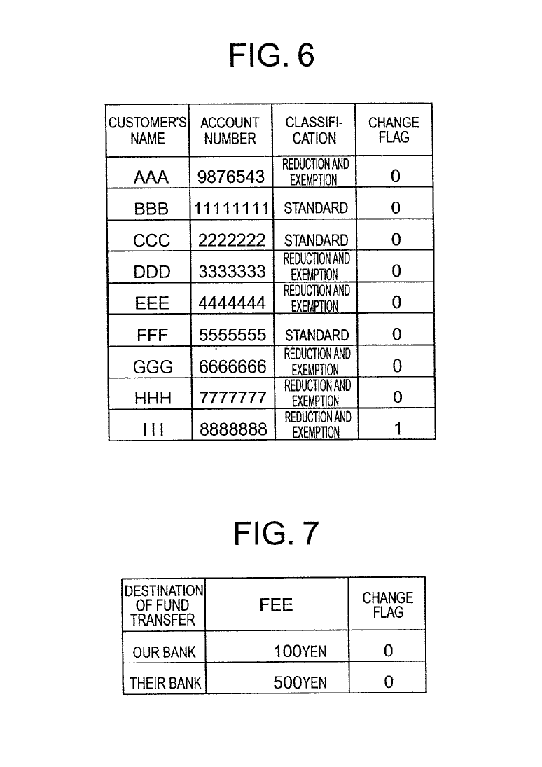

FIG. 6 is a view showing an example of the contents of a customer database 141 of the A bank which the A bank holds in its basic system 131. A customer's name, an account number, the classification relating to whether the standard fee or the reduction and exemption fee is applied when carrying out the fund transfer (fee classification), and a change flag are respectively stored in each of records of the customer database 141. Referring now to FIG. 6, a change flag is set in the record of a business enterprise III. This means that the A bank has changed the fund transfer fee order for the customer III from the standard fee to the reduction and exemption fee.

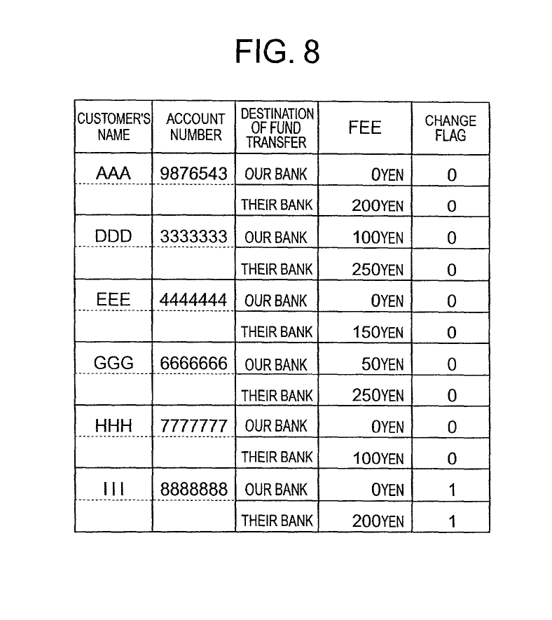

FIG. 7 is a view showing an example of the contents of the standard fee database 142 of the A bank which the A bank holds in its basic system 131. A sum of money of the standard fund transfer fee order for the A bank itself, a sum of money of the standard fund transfer fee order for their banks, and a change flag are respectively stored in the standard fee database 142.

FIG. 8 is a view showing an example of the contents of the reduction and exemption fee database 143 of the A bank which the A bank holds in its basic system 131. A sum of money of the reduction and exemption fund transfer fee order for the A bank itself and a sum of money of the reduction and exemption fund transfer fee order for their banks which are set every customer, and a change flag are respectively stored in the reduction and exemption fee database 143.

In FIG. 6 to FIG. 8, “the change flag”, when there is the change in the corresponding record, is set to “1”. When the customer database 111, the standard fee database 112, and the reduction and exemption fee database 113 in the IB center 101 are subjected to the on-demand update through the date processing, the data of the record in which the change flag is set to “1” is transmitted to be rewritten, whereby the update of the databases 111, 112 and 113 is carried out.

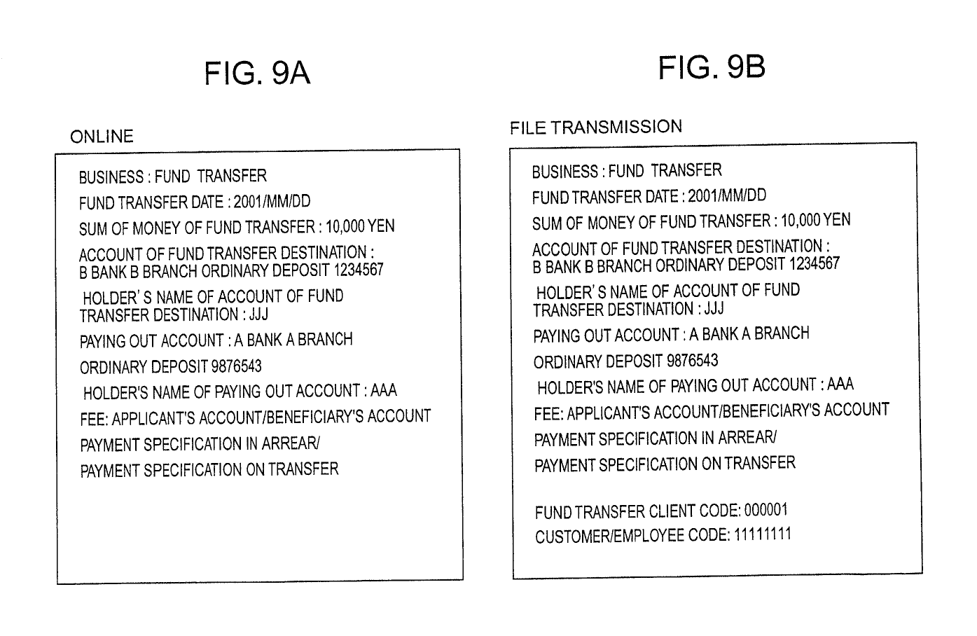

FIG. 9A and FIG. 9B are respectively views each showing one example of the data which when carrying out the fund transfer, a customer (applicant) inputs through his/her terminal. As the input data, there are a kind of business (“fund transfer” in this example), a fund transfer date, a sum of money of the fund transfer, a paying-in account, the holder's name of a paying-in account, a paying-out account, the holder's name of a paying-out account, and a kind of fee (any one of “the applicant's account” and “the beneficiary's account”, and any one of “the payment specification in arrear” and “the payment specification on transfer”). Comparing the case of the online processing shown in FIG. 9A and the case of the file transmission processing shown in FIG. 9B with each other, in the case of the file transmission processing, “fund transfer client code” and “customer/employee code” exhibiting the code of a terminal operator on the applicant side are added to the item as compared with the item in the case of the online processing. The item of the fee is set in such a way that any one of “the applicant's account” and “the beneficiary's account” is selected and also any one of “the payment specification in arrear” and “the payment specification on transfer” is selected.

The description will hereinbelow be given with respect to the procedure of the fund transfer processing by the fund transfer system of the present invention shown in FIG. 1 using the data example shown in FIG. 2 to FIGS. 9A and 9B.

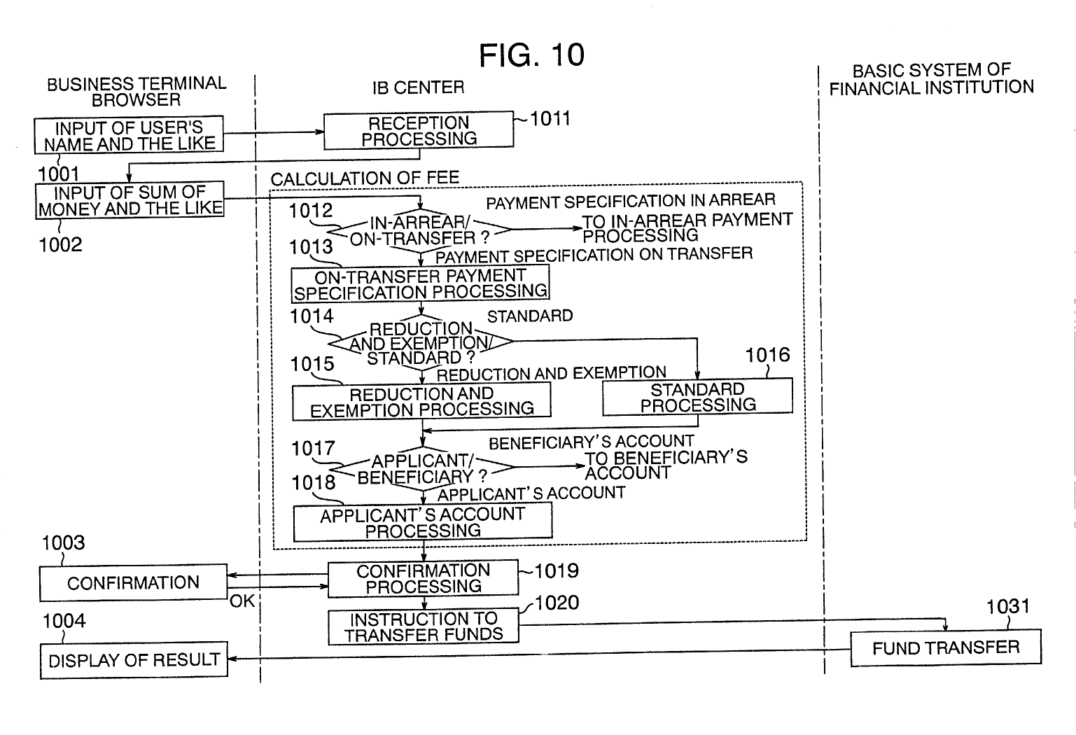

FIG. 10 is a flow chart useful in explaining an example of a fund transfer processing in the case of the file transmission processing, the payment specification on transfer and the applicant's account.

First of all, a customer inputs an applicant's name and a bank's name of a fund transfer source. At this time, the authorization processing employing a customer ID and a pass-word may also be executed. In this case, it is assumed that the A bank as a bank's name, and AAA as an applicant's name are respectively inputted (Step 1001). The reception processing is executed in the center 101 and the data of an input screen is transmitted to the associated one of the terminals (Step 1011). A customer inputs a kind of business (“fund transfer” in this example), a fund transfer date, a sum of money of the fund transfer, a paying-in account, the holder's name of a paying-in account, a paying-out account, the holder's name of a paying-out account, and a kind of fee (any one of “the applicant's account” and “the beneficiary's account”, and any one of “the payment specification in arrear” and “the payment specification on transfer”) through the associated one of the terminals (Step 1002). In this case, for example, as shown in FIGS. 9A and 9B, the necessary matters are inputted and the applicant's account and the payment specification on transfer are selected.

In the center 101, the calculation of the fund transfer fee is carried out on the basis of the data which has been transmitted thereto. First of all, it is judged whether the payment specification of interest is the payment specification in arrear and the payment specification on transfer (Step 1012). Since in this case, the payment specification of interest is the payment specification on transfer, the process proceeds to the on-transfer payment specification processing in Step 1013. The in-arrear payment specification processing will be described later. The center retrieves an A bank table of the customer database 111 (refer to FIG. 2) with an applicant's name AAA as a key, refers to the fee classification which is applied to AAA (Step 1013) and judges in Step 1014 whether the fee is the reduction and exemption fee or the standard fee. Since in the case of this example, the fee is the reduction and exemption fee in step 1013, the process proceeds to the reduction and exemption processing in Step 1015. In the reduction and exemption processing, the A bank table (refer to FIG. 4) in the reduction and exemption fee database 113 is retrieved with the paying-out account (A bank account 9876543) as a key, and 200 yen is acquired as the sum data of the fee since the paying-in account corresponds to a B bank (their bank).

If it is judged in Step 1014 that the fee is the standard fee, then the process proceeds to the standard processing in Step 1016 to retrieve the standard fee database 112 (refer to FIG. 3) to acquire the sum data of the standard fee.

Next, the process proceeds to Step 1017 in which it is judged whether the destination of burden of the fee is the applicant side or the beneficiary side. If it is judged in Step 1017 that the destination of burden of the fee is the applicant side, then the process proceeds to Step 1019. On the other hand, the processing in the case of the beneficiary's account will be described later.

In step 1019, the center 101 generates confirmation information (fund transfer instruction sum: 10,000 yen, fee of the fund transfer: 200 yen, account deduction sum: 10,200 yen) to transmit the confirmation information thus generated to the terminal of AAA as the applicant to press AAA for a confirmation. Then, the applicant AAA confirms the information at its terminal to press down an OK button to transmit the approval data (Step 1003).

By the way, in the confirmation information, the fund transfer instruction sum is a sum of money which an applicant instructs the bank to transfer, and the account deduction sum is the information exhibiting a sum of money which is curtailed from the paying-out account by the processing of transferring the funds exhibited in the fund transfer instruction sum. In addition, the confirmation information may include the items of an applicant's name, a remittee's name, a paying-out account, a paying-in account and the like in addition to the information items which are put up in the foregoing, and so forth on.

In the center 101 which has received the approval of an applicant, the necessary data (the fund transfer of 10,000 yen from the A bank account 9876543 to the B bank account 1234567) is transmitted to the bank basic system 131 to instruct the bank basic system 131 to transfer the funds (Step 1020). Then, the bank basic system 131 which has received the instruction to transfer the funds executes the processing of transferring the funds in accordance with the instruction contents (Step 1031).

More specifically, a sum of money of 10,200 yen which is obtained by adding a B bank fund transfer sum of 10,000 yen and a fee of 200 yen to each other is curtailed from the A bank account 9876543, and 200 yen is imposed as the fee of 200 yen to transfer a specified sum of 10,000 yen to the B bank account 1234567. At the time when the fund transfer has been completed, the bank basic system 131 returns the result back to the center 101, and the center 101 transmits the result transmitted thereto to the terminal of the applicant AAA. Then, the terminal of the applicant AAA displays thereon the result which has been transmitted thereto from the center 101 (Step 1004).

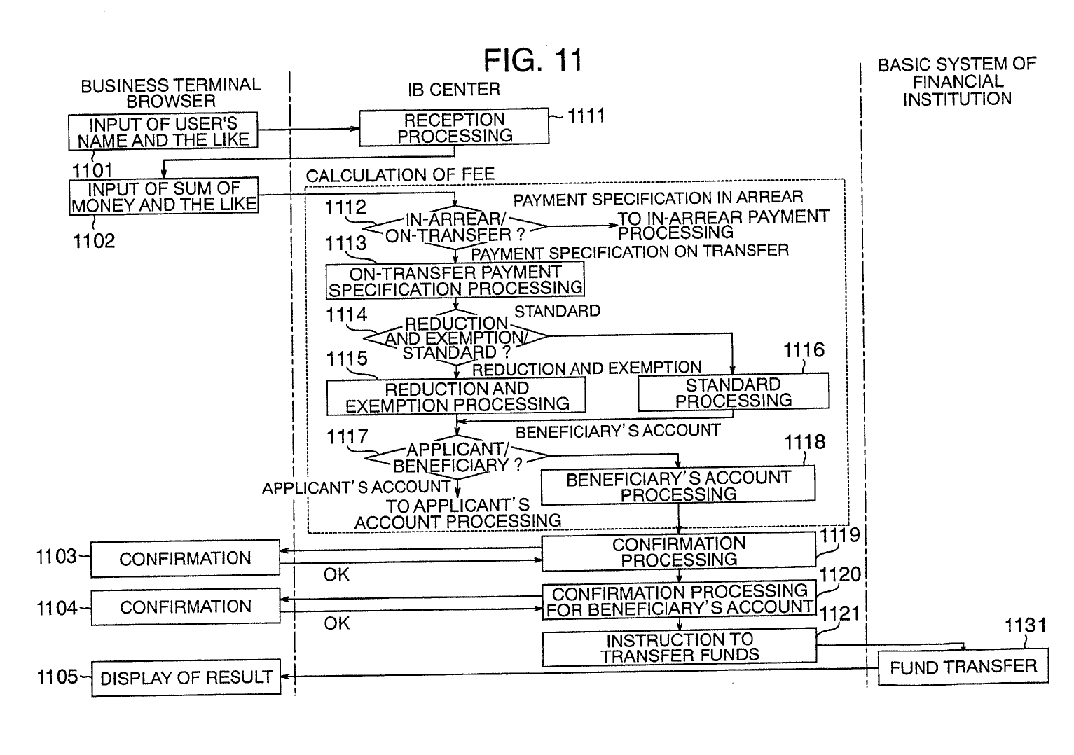

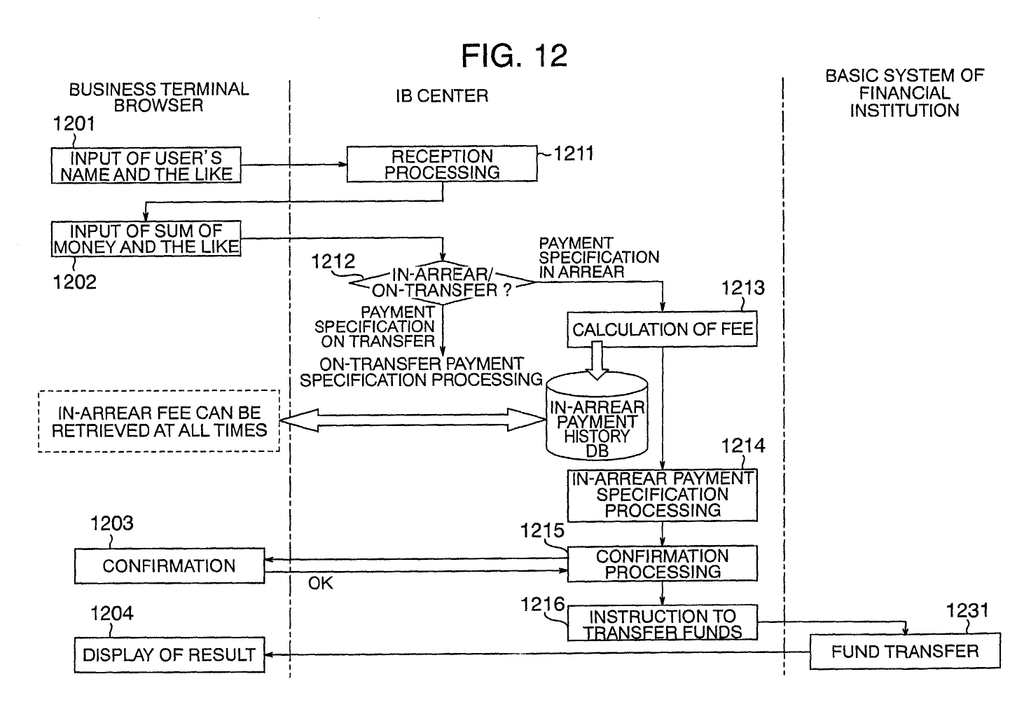

FIG. 11 is a flow chart useful in explaining an example of a fund transfer processing in the case of the file transmission processing, the payment specification on transfer, and the beneficiary's account.

First of all, a customer inputs an applicant's name and a bank's name of the fund transfer source through his/her terminal. At this time, the authorization processing employing a customer ID and a pass-word may also be executed. In this case, it is assumed that the A bank as the bank's name and AAA as the applicant's name are respectively inputted (Step 1101). In the center 101, the reception processing is executed and the data of an input screen is transmitted to the associated one of the terminals (Step 1111). Then, a customer inputs a kind of business (“fund transfer” in this example), a fund transfer date, a sum of money of the fund transfer, a paying-in account, the holder's name of a paying-in account, a paying-out account, the holder's name of a paying-out account, and a kind of fee (any one of “the applicant's account” and “the beneficiary's account”, and any one of “the payment specification in arrear” and “the payment specification on transfer”) through his/her terminal (Step 1102). In this case, as shown in FIGS. 9A and 9B, the necessary matters are inputted and the applicant's account and the payment specification on transfer are selected.

In the center 101, the calculation of the fund transfer fee is carried out on the basis of the data which has been transmitted thereto. First of all, it is judged whether the payment specification of interest is the payment specification in arrear or the payment specification on transfer (Step 1112). Since in this case, the payment specification of interest is the payment specification on transfer, the process proceeds to the on-transfer specification processing in Step 1113. The in-arrear payment specification processing will be described later. The center retrieves the A bank table (refer to FIG. 2) in the customer database 111 with the applicant's name AAA as a key, refers to the fee classification which is applied to the applicant AAA (Step 1113) and judges in Step 1114 whether the fee is the reduction and exemption fee or the standard fee. If it is judged in Step 1114 that the fee is the reduction and exemption fee, then the process proceeds to a reduction and exemption processing in Step 1115. In the reduction and exemption processing, the A bank table (refer to FIG. 4) in the reduction and exemption database 113 is retrieved with the paying-out account (A bank account 9876543) as a key, and since the paying-in account corresponds to the B bank (their bank), 200 yen is acquired as the sum data of the fee.

On the other hand, if it is judged in Step 1114 that the fee is the standard fee, then the process proceeds to a standard processing in Step 1116 in which the standard fee database (refer to FIG. 3) is in turn retrieved to acquire the sum data of the standard fee.

Next, the process proceeds to Step 1117 in which it is in turn judged whether the destination of burden of the fee is the applicant's account or the beneficiary's account. Then, it is judged in Step 1117 that the destination of burden of the fee is the beneficiary's account, then the process proceeds to the beneficiary's account processing in Step 1118. In Step 1118, the center 101 retrieves the beneficiary's account fee from an AAA table in the beneficiary's account database 114 (refer to FIG. 5) with a name of destination of the fund transfer as a key and then in the present embodiment, acquires the data of the burden fee (500 yen) of the business enterprise JJJ.

In Step 1119, the center 101 generates confirmation information (the fund transfer instruction sum: 10,000 yen, the beneficiary's account fee: 500 yen, the account deduction sum: 9,500 yen) to transmit the confirmation information thus generated to the terminal of the customer AAA as the applicant to urge the customer AAA to confirm the information transmitted thereto. Then, the customer AAA confirms the information at his/her terminal to press down the OK button (Step 1103).

Next, in Step 1120, the center 101 executes the processing of reconfirming the beneficiary's account. In the reconfirming processing, the actual fund transfer sum is calculated on the basis of the fund transfer sum and the fee to be transmitted to the terminal of the customer AAA to urge the customer AAA to conform the actual fund transfer sum. In this case, the center 101 generates the information such as the confirmation information (the remittance sum: 9,500 yen, the fee for the fund transfer: 200 yen, the account deduction sum: 9,700 yen) to transmit the information thus generated to the terminal of the customer AAA. Then, the customer confirms the information transmitted thereto at his/her terminal to press down the OK button to transmit the approval data to the center 101 (Step 1104).

By the remittance sum in the confirmation information in Step 1120 is meant a sum of money which is paid in the paying-in account.

By the way, while in the foregoing, the confirmation step by a customer is prepared two times (Step 1119 and Step 1120), two steps may be unified. In this case, Step 1119 is omitted, and the fund transfer instruction sum and the beneficiary's account fee are further added to the confirmation information which is transmitted in Step 1120.

In the center 101 which has received the approval of the applicant AAA, the necessary data (the fund transfer of 9,500 yen from the A bank account 9876543 to the B bank account 1234567) is transmitted to the bank basic system 131 to instruct the bank basic system 131 to transfer the funds (Step 1121). The bank basic system 131 which has received the instruction to transfer the funds from the center 101 executes the processing of transferring the funds in accordance with the instruction contents (Step 1131). To put it concretely, a sum of money of 9,700 yen which is obtained by adding a B bank fund transfer sum of 9,500 yen and the fee of 200 yen to each other is curtailed from the A bank account 9876543, and 200 yen is imposed as the fee to transfer 9,500 yen to the B bank account 1234567.

After completion of the fund transfer, the bank basic system 131 returns the result back to the center 101, and the center 101 transmits the result returned back thereto to the terminal of the customer AAA. Then, the terminal of the customer AAA displays thereon the result which has been transmitted thereto from the center 101 (Step 1105).

By the way, the fund transfer processing in the payment specification on transfer and the applicant's account shown in FIG. 10, and the fund transfer processing in the payment specification on transfer and the beneficiary's account shown in FIG. 11 correspond to the case of the file transmission processing. The flow of the fee calculation when the fund transfer in the payment specification on transfer and the applicant's account, or the fund transfer in the payment specification on transfer and the beneficiary's account is carried out in the online processing is respectively roughly identical to that in shown in FIG. 10 or FIG. 11. But, since during the online processing, the databases of the bank basic system 131 can be utilized in the online manner, in Step 1015 of FIG. 10 or Step 1105 of FIG. 11, instead of the reduction and exemption fee database 113 which is held by the IB center 101, it is also possible to utilize the reduction and exemption fee database 143 which is held by the bank basic system 131. Likewise, in Step 1016 of FIG. 10 or Step 1106 of FIG. 11, instead of the standard fee database 112 which is held by the center, it is also possible to utilize the standard fee database 142 which is held by the bank basic system 131.

FIG. 12 is a flow chart useful in explaining the processing in the case of the payment specification in arrear. By the way, in the case of the payment specification in arrear, the same flow is applied to the case of the online processing as well as to the case of the file transmission processing.

First of all, a customer inputs an applicant's name and a bank's name of the fund transfer source through his/her terminal. At this time, the authorization processing employing a customer ID and a pass-word may also be executed. In this case, it is assumed that the A bank as a bank's name and AAA as an applicant's name are respectively inputted (Step 1201). The center 101 executes the reception processing and transmits the data of the input screen to the associated one of the terminals (Step 1211). An applicant inputs a kind of business (“fund transfer” in this example), a fund transfer data, a sum of money of the fund transfer, a paying-in account, a paying-in account holder's name, a paying-out account, a paying-out account holder's name, and a kind of fee (any one of “applicant's account” and “beneficiary's account”, and any one of “payment specification in arrear” and “payment specification on transfer”) through his/her terminal (Step 1202). In this case, for example, as shown in FIG. 9, the necessary matters are inputted and the payment specification in arrear is selected. If the payment specification in arrear is specified, then the applicant's account is automatically selected.

In the center 101, the calculation of the fund transfer fee is carried out on the basis of the data which has been transmitted thereto. First of all, it is judged whether the payment specification of interest is the payment specification in arrear or the payment specification on transfer (Step 1212). In the case of this example, since the payment specification of interest is the payment specification in arrear, the process proceeds to a fee calculating processing in Step 1213. In the fee calculating processing in Step 12113, the fee calculation is carried out through the same procedure as that in Steps 1013 to 1016 of FIG. 10, and the number of payment specifications in arrear and the sum of in-arrear payment fees are accumulated in the in-arrear payment history database 115. Next, an in-arrear payment specification processing in Step 1214 is executed and then the process proceeds to a confirmation processing in Step 1215. In the information processing, the center 101 generates the confirmation information (the fund transfer instruction sum: 10,000 yen, the fee: the payment specification in arrear, the account deduction sum: 10,000 yen) to transmit the confirmation information thus generated to urge an applicant to confirm the confirmation information transmitted thereto. Then, the applicant confirms the information at his/her terminal to press down the OK button (Step 1203) to transmit the approval data to the center 101.

In the center 101 which has received the approval of the applicant, the necessary data (the fund transfer of 10,000 yen from the A bank account 9876543 to the B bank account 1234567; the fee is the payment specification in arrear) is transmitted to the bank basic system 131 to instruct the bank basic system 131 to transfer the funds (Step 1216). The bank basic system 131 which has received the instruction to transfer the funds from the center 101 executes a processing of transferring the funds in accordance with the instruction contents (Step 1231). To put it concretely, a sum of money of 10,000 yen to be transferred to the B bank is curtailed from the A bank account 9876543 to transfer a specified sum of 10,000 yen to the B bank account 1234567. After completion of the movement of the funds, the bank basic system returns the result back to the center 101 and the center 101 transmits the result returned back thereto to the terminal of the applicant. The terminal of the applicant displays thereon the result transmitted thereto from the center 101 (Step 1204). Thereafter, the financial institution requests the applicant to transfer the in-arrear payment fee at suitable time.

Next, the description will hereinbelow be given with respect to the maintenance of the databases which are held in the center 101. The customer tables in the beneficiary's account database 114 of the databases which are held in the center 101 can be accessed by the corresponding customers, respectively, to carry out the correction and the like of the data. At this time, in the center 101, the accessible data can be limited to a predetermined range by the authorization system employing a customer ID and a pass-word. In addition, the maintenance of the customer database 111, the standard fee database 112, and the reduction and exemption fee database 113 is carried out from the side of the bank basic system 131.

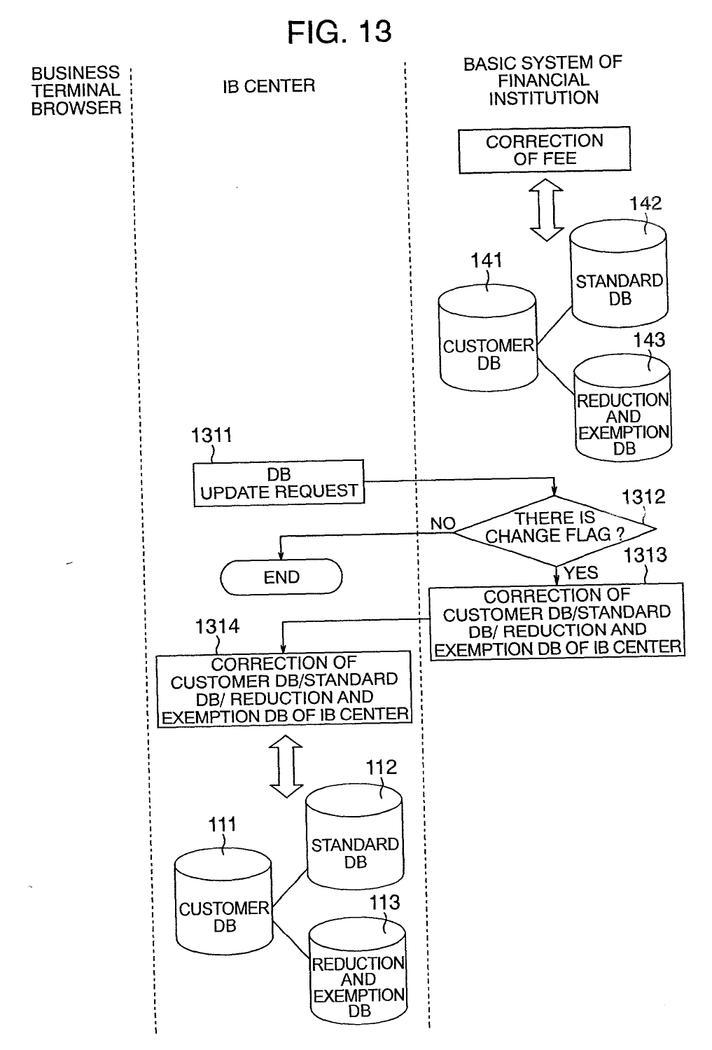

FIG. 13 is a view useful in explaining the on-demand date updating processing of updating the customer database 111, the standard fee database 112, the reduction and exemption fee database 113 which are held on the side of the center 101. Each of banks, as shown in FIGS. 6, 7 and 8, holds in its basic system 131 the customer database 141, the standard fee database 142, and the reduction and exemption fee database 143 and also corrects suitably the contents thereof. In the corrected code, the change flag is set to “1”. The center 101 requests the bank basic system 131 to update the databases (Step 1311). The bank basic system 131 retrieves the databases which are held therein to judge whether the change flag is set to “1” (Step 1312). If it is judged in Step 1312 that the change flag is set to “1”, then the changed data is transferred to the center 101 (Step 1313), and then the center 101 updates the classification of the customer III shown in FIG. 2 to the reduction and exemption on the basis of the information transferred thereto to add the information of the customer III to FIG. 4 (Step 1314). From the foregoing, the records of the databases which are held by the center 101 are updated in such a way as to match those of the databases which are held by the bank basic system 131.

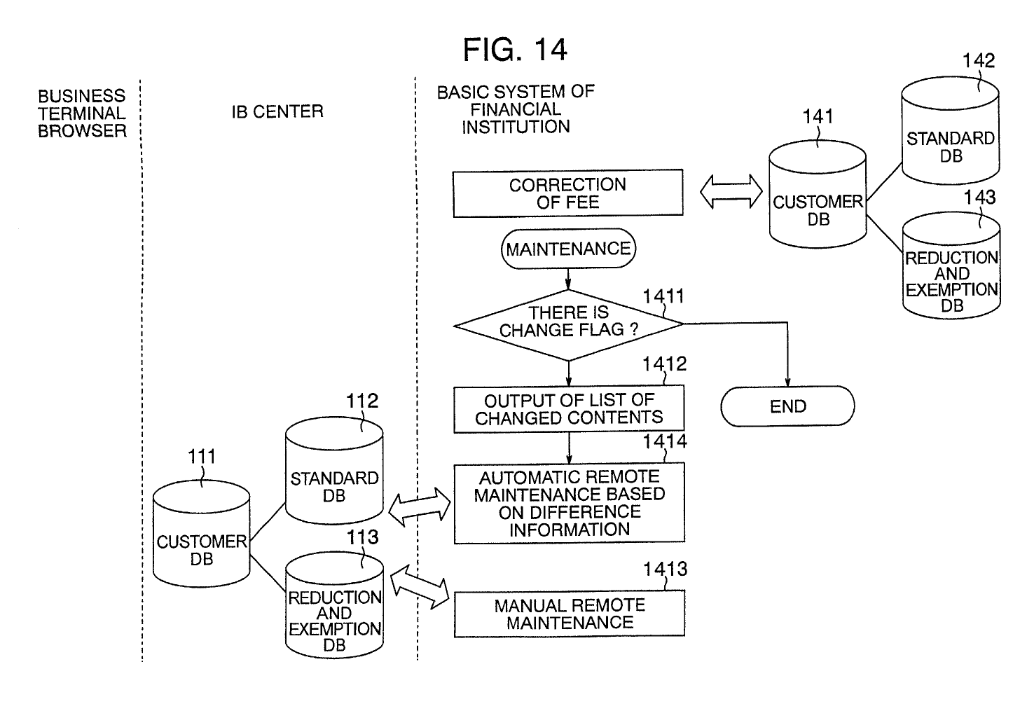

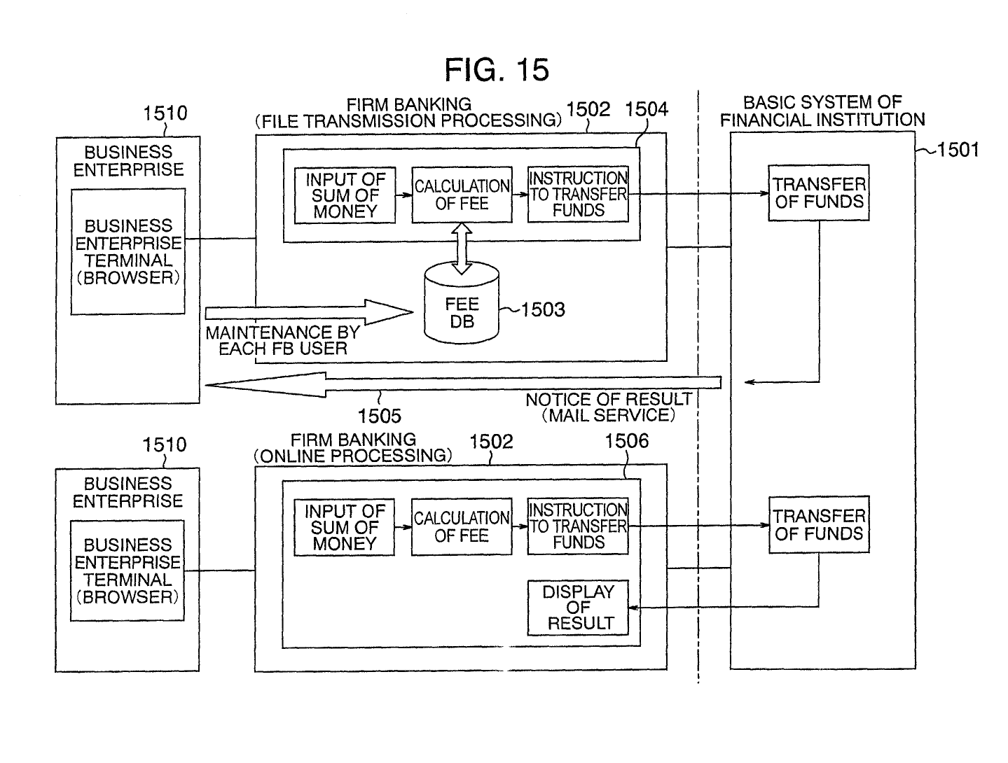

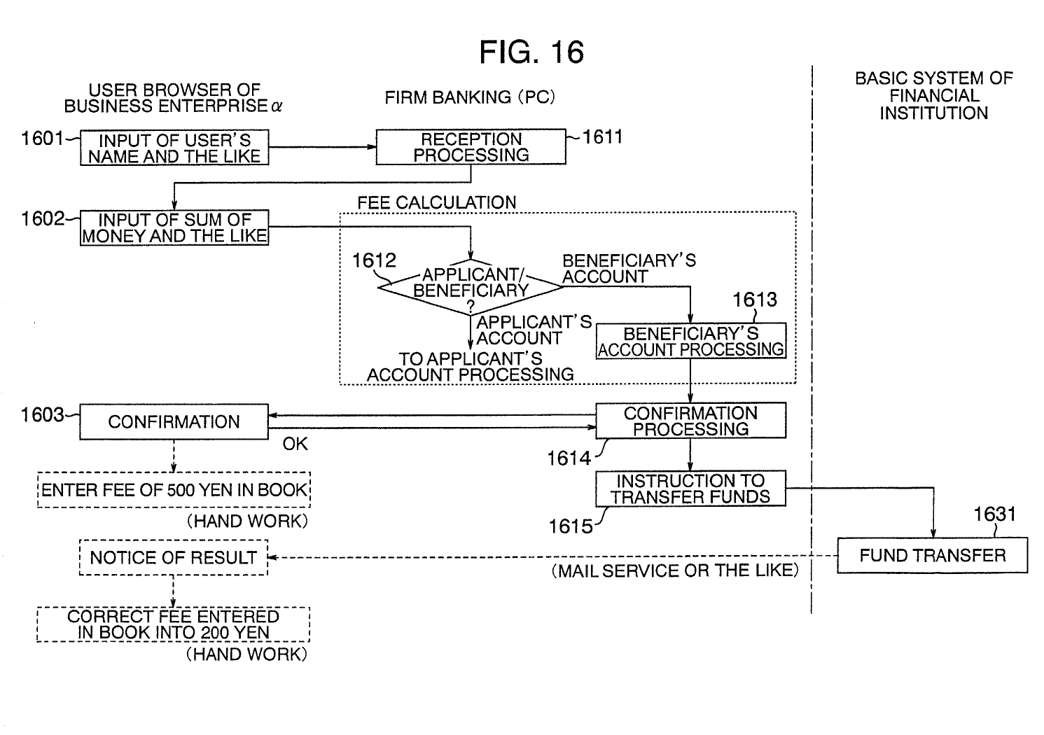

FIG. 14 is a view useful in explaining the remote maintenance of the customer database, the standard fee database, and the reduction and exemption fee database which are held by the center 101. Each of banks, as shown in FIGS. 6, 7 and 8, holds in its basic system 131 the customer database 141, the standard fee database 142 and the reduction and exemption fee database 143 and corrects suitably the contents thereof. In the corrected record, the change flag is set to “1”. The bank basic system 131 retrieves the databases which are held therein to judge whether or not the change flag is set to “1” (Step 1411). If there is the record in which the change flag is set to “1”, then a list of the changed contents is outputted (Step 1412). Then, each of banks accesses the databases which are held in the center 101 to carry out the remote maintenance in accordance with the list (Step 1413). Or, each of banks carries out automatically the remote maintenance on the basis of the difference information (Step 1414). From the foregoing, according to the present invention, the fund transfer fee can be unifiedly managed, the fund transfer fee can be updated from the financial institution side, and a customer can simply retrieve the accurate fee.

In addition, the processing for the fee following the fund transfer can be simplified, and hence the efficiency in the fund transfer business of a customer can be enhanced.

Further, the remote maintenance of the fund transfer fee database can be carried out from the financial institution side, or the fund transfer fee database can be updated on the basis of the on-demand to the basic system of the financial institution. Also, the applicant's account database can be maintained by each of the business enterprises.

According to the present invention, the following effects can be offered.

The reduction and exemption/standard fee becomes the accurate numeric value in the file transmission processing, and hence the fee can be used in the business strategy (the measure of the favorable treatment for customers) of the financial institution.

The person in charge of the business in the financial institution is released from the maintenance by the hand work by the person in charge of the business of the financial institution or by the customer side business enterprise.

The reduction and exemption of a fee can be dealt with in the online processing, and hence the fee can be used in the business strategy (the measure of the favorable treatment for customers) of the financial institution.

The person in charge of the business is released from the complicatedness of calculating the beneficiary's account fee by a hand work in the online processing.

In the online processing, the accurate fee can be calculated even during the unconnection of the basic system of the financial institution.

The in-arrear payment specification/the on-transfer payment specification can be carried out from a customer side.

A customer can simply retrieve the accurate fee for each of the fund transfer cases.

While the present invention has been particularly shown and described with reference to the embodiments and the specified modifications thereof, it will be understood that the various changes and other modifications will occur to those skilled in the art without departing from the scope and true spirit of the invention. The scope of the invention is therefore to be determined solely by the appended claims.

What is claimed is:

1. A fund transfer system comprising:
a database by financial institution in which standard fee data, and reduction and exemption fee data of fund transfer, and data describing whether a fund transfer fee to be applied to each of instruction sources is a standard fee or a reduction and exemption fee are stored separately for financial institutions;
a data base by fund transfer source in which beneficiary's account fee data of the fund transfer is stored separately for fund transfer instruction sources; and
a fund transfer processing unit for on the basis of information relating to a dealing financial institution, information relating to the fund transfer instruction source, information relating to a sum of money of fund transfer and a destination of fund transfer, and information relating to an account source of a fee of fund transfer which is contained in a fund transfer instruction received from a terminal of a fund transfer instruction source, retrieving said database by financial institution and said database by fund transfer source to calculate a fee of fund transfer, which the fund transfer source is to pay the dealing financial institution, and a sum of money of fund transfer to the specified paying-in account, transmitting information of the fee of the fund transfer and the sum of money of fund transfer which have been calculated to said terminal of the fund transfer instruction source, and transmitting information relating to a paying-out account and a paying-in account which are contained in the fund transfer instruction and the information relating to the calculated sum of money of fund transfer to a system of the dealing financial institution.

2. A fund transfer system according to claim 1, wherein only the corresponding financial institution is permitted to update-access said database by financial institution, and only the corresponding source of fund transfer instruction is permitted to update-access said database by source of fund transfer instruction.

3. A method of when receiving fund transfer instruction information, processing the fund transfer instruction information in a center apparatus connected to customer terminals and having a database, wherein there are successively executed the steps of:
receiving fund transfer instruction information as information, on the basis of which the fund transfer from a predetermined paying-out account to a predetermined paying-in account is instructed, from the associated one of said customer terminals;
retrieving a fund transfer fee which has been set in a customer who transmitted fund transfer instruction information, and a beneficiary's account fee which when carrying out the fund transfer to the predetermined paying-in account, the customer receives from a remittee for the fund transfer from said database on the basis of customer identification information contained in the fund transfer instruction information;
calculating a sum of money which is to be curtailed from the predetermined paying-out account on the basis of the fund transfer instruction information, the fund transfer fee thus set and the beneficiary's account fee; and
transmitting the sum of money thus calculated and the fund transfer fee to the associated one of said customer terminals.

4. A method of processing fund transfer instruction information according to claim 3, wherein the beneficiary's account is zero.

5. A method of when receiving an instruction to process a fund transfer, processing fund transfer instruction information in a center apparatus connected to customer terminals, wherein there are successively executed the steps of:
receiving fund transfer instruction information from the associated one of said customer terminals;
referring to a customer information recording unit in which the information of customers is stored on the basis of customer identification information contained in the fund transfer instruction information to judge whether or not a reduction and exemption fee is set in the customer who has transmitted the fund transfer instruction information;
when the reduction and exemption fee is set in the customer who has transmitted the fund transfer instruction information, referring to a reduction and exemption information recording unit to calculate, on the basis of paying-out account information and paying-in account information contained in the fund transfer instruction information, a fee when the customer who has transmitted the fund transfer instruction transfers the funds from an account exhibited in the paying-out account information to an account exhibited in the paying-in account information;
judging on the basis of the fund transfer instruction information whether or not the fee required for the fund transfer processing exhibited in the fund transfer instruction information is charged to the customer who has transmitted the fund transfer instruction information of interest;
when such a fee required for the fund transfer processing exhibited in the fund transfer instruction information is not charged to the customer who has transmitted the fund transfer instruction information of interest, retrieving a beneficiary's account fee which is set by the customer who has transmitted the fund transfer instruction information from a beneficiary's account information recording unit;
calculating a sum of money which is curtailed along with the fund transfer based on the fund transfer instruction information from the paying-out account on the basis of the beneficiary's account fee thus retrieved, the fee required when carrying out the above-mentioned fund transfer, and a sum of money for the fund transfer exhibited in the fund transfer instruction information; and
transmitting the sum of money thus calculated and the fee when carrying out the above-mentioned fund transfer to the associated one of said customer terminals.

6. A method of processing fund transfer instruction information for use in a center apparatus connected to terminals of customers and a basic system held by a financial institution for transmitting fund transfer instruction information containing applicant information used to identify the associated one of said terminals of customers, remittee information used to identify a remittee of the fund transfer by the customer, and fund transfer sum information as information exhibiting a sum of money of the funds transferred by the customer which have been sent from the associated one of said terminals,
wherein said center apparatus includes a first recording unit in which a fund transfer fee which said financial institution imposes from the customer when carrying out an instruction to process fund transfer is stored, and a second recording unit in which a beneficiary's account fee which the customer imposes from the remittee whenever carrying out the fund transfer is stored, and
wherein said method comprises the steps of:
receiving the fund transfer instruction information from the associated one of said terminals;
acquiring the fund transfer fee from said first recording unit;
on the basis of the remittee information, acquiring the beneficiary's account fee from said second recording unit;
on the basis of the acquired fund transfer fee, the acquired beneficiary's account fee and the information, generating, when carrying out the fund transfer, confirmation information containing a sum of money which is curtailed from a paying-out account as a transfer source of the funds and a breakdown of the sum of money; and
before the fund transfer instruction information is transmitted to said basic system, transmitting the confirmation information to the terminal of the customer who is identified on the basis of the applicant information.

7. A method of processing fund transfer instruction information according to claim 6, wherein the fund transfer fee is set every customer by said financial institution; and said first recording unit stores therein the fund transfer fee every customer, and
wherein said step of acquiring the fund transfer fee comprises the steps of: on the basis of the applicant information, retrieving said first recording unit; and acquiring the fund transfer fee, which is stored in correspondence to the customer identified by the applicant information, by said financial institution.

8. A method of processing fund transfer instruction information according to claim 7, wherein the fund transfer fee is classified into the self-addressed fund transfer fee which is applied when the paying-out account and a paying-in account as an account of the remittee are present in the same financial institution, and an other-addressed fund transfer fee which is applied when the paying-out account and a paying-in account as an account of the remittee are not present in the same financial institution; and said first recording unit stores therein the self-addressed fund transfer fee and the other-addressed fund transfer fee every financial institution, and
wherein said step of acquiring the fund transfer includes the steps of: judging on the basis of the fund transfer institution information whether or not the paying-out account and paying-in account are present in the same financial institution; and on the basis of said judgement step, acquiring one of the self-addressed fund transfer fee and the other-addressed fund transfer fee.

9. A method of processing fund transfer instruction information according to claim 8, wherein the calculation of a sum of money which is contained in the confirmation information and which is curtailed from the paying-in account is carried out on the basis of the subtraction of a sum of money corresponding to the fund transfer fee and the addition of a sum of money corresponding to the beneficiary's account fee from and to the fund transfer sum.

10. A method of processing fund transfer instruction information according to claim 6, wherein the fund transfer instruction information contains information exhibiting whether or not the beneficiary's account fee is charged to the remittee, and when that information exhibits that the beneficiary's account fee is not charged to the remittee, the confirmation information is generated on the basis of the fund transfer fee information and the fund transfer sum without referring to said second recording unit.
